(19) United States
(12) Patent Application Publication
(10) Pub. No.: US 2002/0031608 A1
(43) Pub. Date: Mar. 14, 2002

(54) COATING AND DRYING METHOD

(76) Inventor: KEIICHI AOKI, TOKYO (JP)

Correspondence Address: BIERMAN MUSERLIAN AND LUCAS, 600 THIRD AVENUE, NEW YORK, NY, 10016

(21) Appl. No.: 09/405,988

(22) Filed: Sep. 27, 1999

(30) Foreign Application Priority Data
Nov. 26, 1998 (JP) 335765/1998

(51) Int. Cl. B05D 3/02; B05D 3/04

(52) U.S. Cl. 427/377; 427/378; 427/180; 427/9

(57) ABSTRACT

A coating method is disclosed. The method comprises a step in which a coating composition comprising an organic solvent is coated onto a conveyed support, and a coating film is formed, and a step in which the support coated with said coating composition is dried in a drying zone, and the time prior to entry into said drying zone after said coating composition is coated onto said support is no more than 5 seconds.

### FIELD OF THE INVENTION

The present invention relates to a method in which a coating composition comprising an organic solvent is coated onto a support and subsequently dried.

### BACKGROUND OF THE INVENTION

Conventionally, various types of proposals have been made for coating and drying methods of organic solvent based coating compositions. For example, there are: a method represented by Japanese Patent Publication No. 53-10691 in which heating and drying temperatures are specified, a method represented by Japanese Patent Publication No. 1-57276 in which the direction of heated air flow is specified, and the like. As described above, most methods relate to heated drying zones. In the coating and drying process for the organic solvent based coating composition, unevenness and related problems on the coated film surface occasionally result in the heating and drying zones. However, it has been found that even prior to entry into the drying zone after coating, the unevenness and related problems frequently result. In particular, when the viscosity of a coating composition is low, the unevenness and such problems frequently result prior to entry into the drying zone. Accordingly, it is not sufficient to take measures only in the drying zone against the unevenness and related problems on a coated film surface, but rather it is also necessary to take measures against them during passing of the space at normal temperature prior to entry into the drying zone after coating.

Furthermore, when the coating surface of a support is rough, problems have resulted in which the final film thickness is not uniform due to leveling action during drying even though coating is carried out at a uniform film thickness.

### SUMMARY OF THE INVENTION

The first object of the present invention is to provide a coating method which is capable of minimizing unevenness and such problems on a coated film surface. The second object of the present invention is to provide a coating method which is capable of providing uniform film thickness even though the coating surface of a support is rough.

The coating method of the present invention will now be described.

A coating method comprises the following steps:

a step in which a coating composition comprising an organic solvent is coated onto a conveyed support, and a coating film is formed, and

a step in which the support coated with said coating composition is dried in a drying zone,

After said coating composition is coated onto said support, the time prior to entry into said drying zone is no more than 5 seconds.

In said drying step, said support is preferably heated and dried employing a heating means provided in said drying zone.

After said coating composition is coated onto said support, the air flow rate on said coated film prior to entry into said drying zone is preferably no more than 1 m/second.

The organic solvent contained in the above-mentioned coating composition preferably comprises an organic solvent component having a viscosity of no more than 1 cp, and a boiling point of no more than 100° C. at normal temperature and pressure. The normal temperature and pressure as described herein refer to 20° C. and 1013.25 hPa, respectively.

The above-mentioned coating composition preferably comprises a surface active agent.

The above-mentioned coating composition preferably comprises solid particles which are not soluble in the same.

The center line average height of the coating surface of the above mentioned support is preferably at least 0.3 μm.

The coating method comprises the following steps:

a step in which a coating composition comprising an organic solvent is coated onto a conveyed support, and

a step in which the support coated with said coating composition is dried in a drying zone.

After said coating composition is coated onto said support, an air flow rate on said coated film is preferably no more than 1 m/second until entry into said drying zone.

### BRIEF DESCRIPTION OF THE DRAWINGS

FIG. 1 is a schematic view showing the positional relationship between coating and drying sections of a coating and drying apparatus.

FIG. 2a is a cross-sectional view showing the state at completion of coating and drying of the coated surface of a support (present invention).

FIG. 2b is a cross-sectional view showing the state at completion of coating and drying of the coated surface of a support (control).

FIG. 3 is a schematic view of a drying apparatus.

FIG. 4 is a cross-sectional view along A-A in FIG. 3

FIG. 5 is a schematic view of a drying apparatus

FIG. 6 is a cross-sectional view along B-B in FIG. 5.

### DETAILED DESCRIPTION OF THE INVENTION

During coating and drying of an organic solvent based coating composition, even though normal coating is carried out at a coater, problems frequently occur, in which after drying, unevenness and related problems on the coated film surface result. Such unevenness and such problems generally occur in the drying zone. However, it has been found that they often occur prior to entry into the drying zone after coating. Generally, as the viscosity of a coating composition decreases, the ease of normal coating increases. For example, a low viscosity yields advantages such as higher speed coating and the like. However, it has been found that as the viscosity of the coating composition decreases, unevenness and related problems tend to result prior to entry into a drying zone.

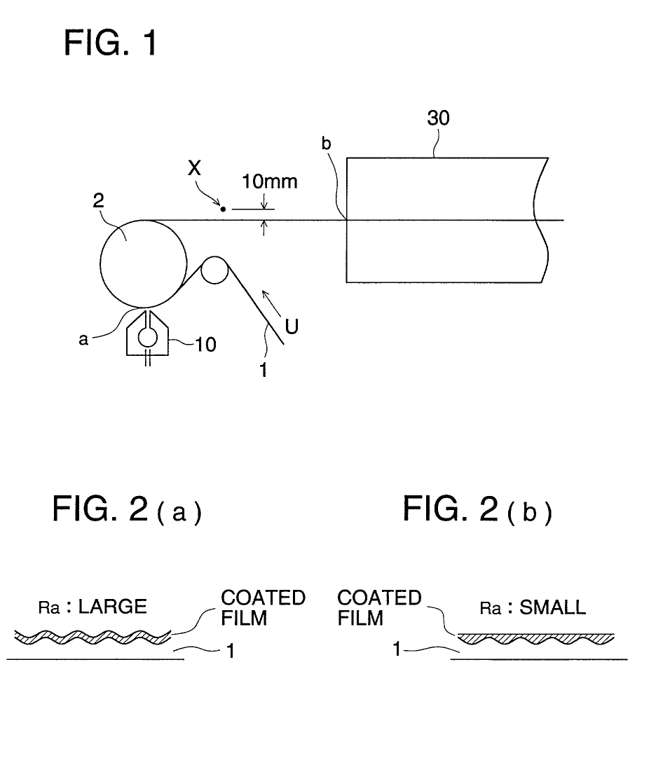

Namely, such unevenness and related problems, which result prior to entry into the drying zone, have been analyzed. As a result, phenomena have been confirmed in which a wet coated film immediately after coating is readily affected by ambient air flow due to its low viscosity, to result in differences in thickness (uneven film thickness) of the wet coated film, or when foreign substances are adhered to a coated film, spot defects are formed because the coating composition pools around the foreign substance. Ventilation in the space between the coater arranged in a coating zone, which ejects coating compositions and coats the coating compositions onto a support and the drying zone, is essential to assure the safety for work environment, explosion-proof, and the like to result in an air flow. Further, in the coating zone, workers are more often present, compared to the drying zone. As a result, ambient dust and the like tend itself to attach onto the coated film. Under such conditions, it is difficult to eliminate the air flow, as well as dust, in the space. In order to solve these problems, it has been found to be effective that the retention time in the space at normal temperature prior to entry into the drying zone is shortened so that the coated film is conveyed to the drying zone within a shorter period. This shortens the time of the coated film in the low viscosity state, which is easily affected by external turbulence so that by introducing the coated film to the drying zone within a shorter period, the solvent in the coated film is more rapidly evaporated to promote an increase in the viscosity. It has also been found that when the time prior to entry into the drying zone after coating was adjusted to no more than 5 seconds, a good coated film surface was obtained. Further, said time is preferably not more than 3 seconds. The time prior entry into the drying zone after coating as described herein is time, as illustrated in FIG. 1, when an arbitrary point on a conveyed support is denoted point “a”, the time from the contact of a coating composition on point “a” to the entrance into said drying zone, that is, from the contact of the coating composition at point “a” until point “a” passes point “b” (for example, the coating process side wall of a box which houses said drying zone) positioned at the entrance of the drying zone. In FIG. 1, description is made using an extrusion coating method employing a coater as an example. However, the coating method is not limited to this and any methods such as a curtain coating method and the like may be employed, as long as coating can be carried out onto a support during conveyance. Further, the conveyance speed of the support is preferably between 0.5 and 1000 m/minute. Methods employed in the drying zone are also not particularly limited. Heat drying and the like may be employed, and a heated air flow, infrared ray irradiation, and the like are employed.

Furthermore, as described above, said space is preferably ventilated. A device in which an air flow in the space is adjusted, so that the air flow does not directly hit the coated film surface, is effective in minimizing the formation of unevenness; in such a manner that, for example, an air duct is arranged so that it is not directed onto the coated film surface; an air flow screening plate is arranged near the coated film; no air is blown from a dryer; and the like. Specifically, the air flow rate onto the coated film is preferably no more than 1 m/second.

The air flow rate on the coated film may be measured as follows. Under conditions which are employed for coating and drying, the air flow rate is measured at a point where coated film passes, while the support is not conveyed. Furthermore, as the examples described below, the air flow rate may be measured at a point apart from the coated film, if the air flow rate at the point is not much different from that on the coated film. Preferred examples to decrease the air flow rate will now be described.

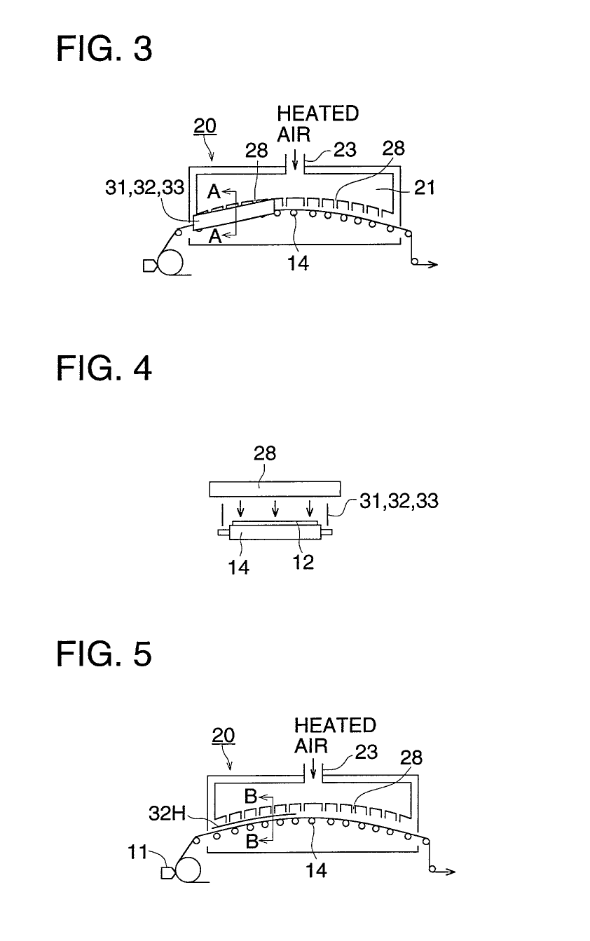

Other than drying air which is blown onto a coated film for drying, listed as the air flow which distorts the coated film to result in uneven thickness is an external turbulent air flow formed by suction and exhaust to control air conditioning of the entire drying apparatus 20. The drying apparatus 20 comprises an air exhaust outlet which discharges into the exterior of the apparatus, solvent vapor which was released into the apparatus due to drying and a supply outlet 23B serving as a drying air outlet 28 which is supplied to blow on the coated film to maintain a constant interior temperature of the apparatus and a constant solvent vapor amount. These are arranged downstream of the conveying direction of support 12 so that the coated film is not distorted. However, it is impossible to eliminate the external turbulent air flow. Said external turbulent air flow turns around from both edges of the support and results in unevenness of the coated film. Therefore, as shown in the schematic view and cross-sectional view of FIGS. 3, and 4, air flow screening plate 31 is preferably provided at the exterior side of both edges of the support 12. The air flow screening plate, when positioned within 10 cm from the edge of the support 12 results in its effect. When the air flow screening plate is positioned beyond 10 cm, the external turbulent air flow enters between the air flow screening plate 31 and the support 12, and the distortion of the coated film results. The range, in which the air flow screening plate is provided, is preferably one in which the support with its coated film highly fluid passes.

Air blown onto a coated surface for drying is occasionally not eliminated well enough from the support surface due to the size of the air flow screening plate 31. Accordingly, said air flow screening plate is modified into flow regulating plate 32, having an opening ratio of 50% to 80%, and thus the external turbulent air flow from the edge direction of the support 12 is not allowed to reach the coated surface of the support 12, and a flow path can be provided which eliminates blown air for drying the coated surface from the surface of the support 12.

Employed as the air flow regulating plate may be a punched plate. The optimal hole diameter of said punched plate varies depending on conditions of the drying air, however it is preferably between 1 and 20 mm. It is more preferably between 1 and 10 mm. When a punched plate having a hole diameter of 20 mm and more is employed, unevenness is occasionally formed on the coated film surface due to the difference in the air flow over the hole portions and the solid portions. Employed as another embodiment of the flow regulating plate 32 may be a slit plate. The optimal slit width of said slit plate varies depending on conditions of the drying air, however it is preferably between 1 and 20 mm. It is more preferably between 1 and 5 mm. When the slit plate having a slit width of at least 20 mm is employed, unevenness occasionally results on the coated film surface due to the difference in the air flow over the slit portions and the solid portions. Employed as still another embodiment of the flow regulating plate 32 may be a mesh plate. The optimal mesh size varies depending on conditions of the drying air, however, it is preferably 50 mesh or finer. It is more preferably 100 mesh or finer. When the mesh plate having a mesh of no finer than 50 mesh, unevenness occasionally results on the coated film surface due to blown air.

The air flow screening plate 31 may be employed as an air intake 33. Said intake 33 is not only capable of minimizing the reach of external turbulent air flow onto the coated film surface, but is also capable of efficiently removing blown drying air from the support surface without forming air turbulence. The intake is preferably positioned within 10 cm from the edge of the support in the same manner as the screening plate. The installment range is preferably one through which the support passes, while the coated film is in a state of high fluidity.

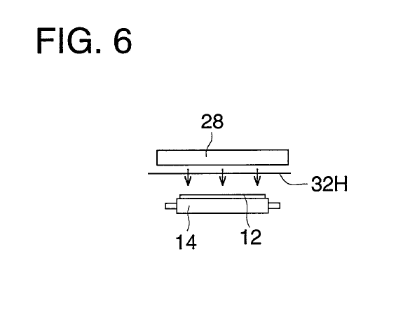

In order to change air blown onto the coated film surface for drying the coated surface into an air flow which is uniform and does not cause unevenness of the coated film, as shown in the schematic view of FIG. 5 and the B-B cross-sectional view of FIG. 6, between the nozzle of drying air and the support having a surface to be dried, air flow regulating plate 32H, having an opening ratio of 5 to 80 percent, may be provided in a position at least 10 cm from nozzle 28. The flow rate of air, which is supplied from drying air supply port 23 and is ejected from the nozzle 28 decreases until it reaches the coated film surface. However, when air just after being blown, having a relatively high flow rate, is allowed to pass through the air flow regulating plate 32H, on the contrary, the coated film occasionally results in unevenness. When the air flow regulating plate is positioned at least 10 cm from the nozzle, the flow rate of air ejected from the nozzle 28 decreases to some extent to make it possible to generate uniform air flow without turbulence.

Employed as said air flow regulating plate 32H may be a punched plate. The optimal hole diameter of said punched plate varies depending on conditions of the drying air, however it is preferably between 1 and 20 mm, while it is more preferably between 1 and 10 mm. When the punched plate having a hole diameter of at least 20 mm is employed, mottling due to air impingement is occasionally formed on the coated film surface due to the difference in the air flow over the hole portions and the solid portions. Employed as another embodiment of the air flow regulating plate 32H may be a slit plate. The optimal slit width of said slit plate varies depending on conditions of the drying air, however it is preferably between 1 and 20 mm., while it is more preferably between 1 and 5 mm. When the slit plate having a slit width of at least 20 mm is employed, mottling due to air impingement occasionally occurs on the coated film surface due to the difference in the air flow over the slit portions and the solid portions. Employed as still another embodiment of the air flow regulating plate 32 may be a mesh plate. The optimal mesh size varies depending on conditions of the drying air, however, it is preferably 50 mesh or finer, while it is more preferably 100 mesh or finer. When the mesh plate has a mesh of no finer than 50 mesh, mottling due to air impingement occasionally forms on the coated film surface.

The range in which the flow regulating plate is preferably one through which the support passes, while the coated film is in a state of high fluidity.

In order to maintain a constant interior temperature and a constant air flow rate, the drying apparatus 20 is covered to form a box, while leaving an opening through which a support can pass, and the pressure difference between the interior and the exterior is generated by air supply as well as air exhaust. Owing to the said pressure difference, in the opening through which support 12 entering the drying apparatus after coating passes, an air flow is generated by the pressure difference between the apparatus interior pressure in drying box 21 and the air pressure of a coating room in which coater 11 is installed. When the apparatus interior pressure is higher than the air pressure in the coating room, air at a high temperature in the drying process flows along the coated surface which has not yet dried from the opening through which the support passes to result in mottling due to air impingement. When the apparatus interior pressure is lower than the air pressure in the coating room, said mottling due to air impingement is not likely because the air flow in the drying apparatus 20 is regulated. Accordingly, it is preferred that the air in the coating room flows into the drying box 21 of the drying process 20 by keeping the apparatus interior pressure of the drying process lower than the air pressure in the coating room. When the air in the coating room flows into the drying apparatus 20, excessive pressure difference may be a cause to distort the coated film surface. Accordingly, the pressure difference between the interior pressure of the drying apparatus 20 and the air pressure in the coating room is preferably no more than 10 mm H₂O, is more preferably no more than 5 mm H₂O, and is most preferably no more than 1 mm H₂O.

In order to maintain the interior pressure of the drying apparatus 20 lower than the air pressure of the coating room, the pressure of the drying process may be kept at a negative pressure because the air pressure in the coating room is generally the same as the atmospheric pressure. Specifically, it is achieved by regulating the air amount exhausted to the exterior from the drying process to be greater than the air amount supplied to the drying process from the exterior.

When a coating composition is applied having a viscosity of no more than 10 cp, particularly, unevenness or related problems tend to result. Further, when the coating composition having a viscosity of no more than 5 cp is applied, such trend is enhanced. At that time, in many cases, the coating composition comprises solvent components having a low viscosity, which preferably have high volatility, and such highly volatile solvent is readily evaporated. Accordingly, the viscosity of a coated film can be rapidly increased so that the coated film is not likely to be influenced by external turbulence. Specifically, at normal temperature and pressure (that is, at 20° C. and 1013.25 hPa), it is particularly effective for a coating composition to be comprised of an organic solvent having a viscosity and a boiling temperature of no more than 10 cp and no more than 100° C., respectively. Listed as examples of solvent meeting these requirements are methanol, ethanol, n-propanol, isopropanol, tetrahydrofuran, acetone, methyl ethyl ketone, methyl acetate, ethyl acetate, and the like. These solvents are particularly effective, when the content ratio of them is at least 20 percent of the total solvent weight incorporated into the coating composition.

It has been found that the above-mentioned spot defects, due to foreign substances adhered onto a coated film, are particularly enhanced by a coating composition comprising surface active agents. The representative surface active agents include fluorine based surface active agents, siloxane based surface active agents, and the like. It is assumed that the surface active agent orients itself around the foreign substance and attracts the coating composition. In order to solve this problem, it is effective to rapidly increase the viscosity of the coated film because a coating composition having high viscosity moves slowly.

Further, some coating compositions comprise solid particles which are not soluble. For example, those include matting agents which provide unevenness on a coated film surface. Such coating composition occasionally pools around said solid particle due to the same action as for the above-mentioned foreign substances. In order to solve this problem, it is effective to rapidly increase the viscosity. It was confirmed that this is effective when the diameter of the sold particles is between 5 and 50 μm.

Furthermore, when the coating surface of a support is rough, namely, when the center line average height is no less than 0.3 μm, problems result in which even though coating is carried out at a uniform film thickness, the final film thickness is not uniform due to leveling action during drying. In particular, in the case of a functional coated film, coated film properties are frequently affected by its thickness, therefore the film thickness is preferably uniform. In order to overcome this problem, it is effective to rapidly increase the viscosity. It has been found that the unevenness of the film thickness is markedly reduced by introducing the coated film into a drying zone having a heating means within 5 seconds after coating. In particular, when the viscosity of the coating composition is low, the film thickness tends to be non-uniform. When the viscosity of a solvent incorporated into a coating composition is no more than 1 cp at normal temperature and pressure, it is effective to enhance its evaporation at the early stage to increase its viscosity while employing a solvent having a boiling point of no more than 100° C.

The present invention is particularly advantageous when the wet coated film thickness is thin, and especially when the wet film thickness is between 5 and 200 μm.

Supports which are employed for the present coating method are not particularly limited and it may be applied to supports composed of paper, plastics, metal and the like. Listed as representative materials for the supports are polyethylene terephthalate as a plastic, aluminum as a metal, and the like.

### EXAMPLES

### Examples 1 through 9

With the use of the coating and drying apparatus schematically shown in FIG. 1, coating was carried out onto 300 mm wide and 100 μm thick polyethylene terephthalate support 1 having a center line average height Ra of 0.2 μm, while varying coating compositions, coating speed U, air flow rate v at position X which is 10 mm above the coated film. The appearance of the dried coated film was then evaluated. The coating was carried out employing extrusion type coater head 10, so as to obtain a wet film thickness of 20 μm. As shown in FIG. 1, the distance from the coating point “a” to the support 1, which is near the contact portion of the above-mentioned coater head 10, with back-up roller 2, to the entry point “b” to the heating and drying zones 30 was 2 m, and by varying the coating speed, retention time “t” in this zone were varied. Examples 1 through 9 and Comparative Examples 1 through 4 were prepared by applying coating compositions in which types of solvents were varied, coating compositions into which surface active agents were incorporated, and further, coating composition into which matting agents were incorporated. The resulting coatings were evaluated for uneven thickness and spot defects. Employed solvents were combination of two, and the mixing ratio was solvent A solvent B=1:1 in weight ratio. The surface active agent which was added to Comparative Examples 3 and 4, and Examples 6 through 9 was Fluorad FC-431, manufactured by 3M Co. The employed concentration of the surface active agent in the coating composition was 1 percent by weight. Furthermore, the matting agent which was incorporated into Comparative Example 4, and Examples 8 and 9 was composed of silica and had an average particle diameter of 20 μm, while the concentration in the coating composition was 0.1 percent by weight. Table 1 shows the above cited results.

Further, the viscosity and boiling point of each solvent at 20° C. and 1013.25 Pa are as follows; methyl isobutyl ketone, 0.6 cp and 115.90° C.; methyl ethyl ketone, 0.4 cp and 79.57° C.; and cyclohexanone, 2.4 cp and 155.65° C.

TABLE 1

| | | | Viscosity of | | | | | | |
|---|---|---|---|---|---|---|---|---|---|
| | | | Coating | | | | | Evaluation | Evaluation |
| | | | Composition | U | t | V | | of Uneven | of Spot |
| | Solvent A | Solvent B | (cp) | (m/min) | (sec) | (m/sec) | Other | Thickness | Defects |
| Comparative | methyl | cyclo- | 3 | 20 | 6 | 2 | | 3 | 3 |
| Example 1 | isobutyl | hexanone | | | | | | | |
| | ketone | | | | | | | | |
| Example 1 | methyl | cyclo- | 3 | 30 | 4 | 2 | | 4 | 4 |
| | isobutyl | hexanone | | | | | | | |
| | ketone | | | | | | | | |
| Example 2 | methyl | cyclo- | 3 | 40 | 3 | 2 | | 4 | 4 |
| | isobutyl | hexanone | | | | | | | |
| | ketone | | | | | | | | |
| Comparative | methyl | cyclo- | 2 | 20 | 6 | 2 | | 2 | 4 |
| Example 2 | ethyl | hexanone | | | | | | | |
| | ketone | | | | | | | | |
| Example 3 | methyl | cyclo- | 2 | 30 | 4 | 2 | | 4 | 4 |
| | ethyl | hexanone | | | | | | | |
| | ketone | | | | | | | | |
| Example 4 | methyl | cyclo- | 2 | 40 | 3 | 2 | | 5 | 5 |
| | ethyl | hexanone | | | | | | | |
| | ketone | | | | | | | | |
| Example 5 | methyl | cyclo- | 2 | 30 | 4 | 1 | | 5 | 4 |
| | ethyl | hexanone | | | | | | | |
| | ketone | | | | | | | | |
| Comparative | methyl | cyclo- | 2 | 20 | 6 | 2 | addition of | 3 | 2 |
| Example 3 | ethyl | hexanone | | | | | surface active | | |
| | ketone | | | | | | agent | | |
| Example 6 | methyl | cyclo- | 2 | 30 | 4 | 2 | addition of | 4 | 4 |
| | ethyl | hexanone | | | | | surface active | | |
| | ketone | | | | | | agent | | |
| Example 7 | methyl | cyclo- | 2 | 40 | 3 | 2 | addition of | 5 | 5 |
| | ethyl | hexanone | | | | | surface active | | |
| | ketone | | | | | | agent | | |
| Comparative | methyl | cyclo- | 2 | 20 | 6 | 2 | addition of | 3 | 1 |
| Example 4 | ethyl | hexanone | | | | | surface active | | |
| | ketone | | | | | | and matting | | |
| | | | | | | | agent | | |
| Example 8 | methyl | cyclo- | 2 | 30 | 4 | 2 | addition of | 4 | 4 |
| | ethyl | hexanone | | | | | surface active | | |
| | ketone | | | | | | agent and | | |
| | | | | | | | matting agent | | |
| Example 9 | methyl | cyclo- | 2 | 40 | 3 | 2 | addition of | 5 | 4 |
| | ethyl | hexanone | | | | | surface active | | |
| | ketone | | | | | | agent and | | |
| | | | | | | | matting agent | | |
| Example 10 | methyl | cyclo- | 2 | 30 | 4 | 1 | addition of | 5 | 4 |
| | ethyl | hexanone | | | | | surface active | | |
| | ketone | | | | | | agent | | |
| Example 11 | methyl | cyclo- | 2 | 30 | 4 | 1 | addition of | 5 | 4 |
| | ethyl | hexanone | | | | | surface active | | |
| | ketone | | | | | | agent and | | |
| | | | | | | | matting agent | | |

5 grade evaluation

| | | |
|---|---|---|
| 1 | ←→ | 5 |

| | |
|---|---|
| poor | good |

Under the same conditions of the coating compositions, it is found that as an increase in the coating speed, uneven thickness and spot defects are overcome. Regarding the evaluation grade, Grade 5 is best and Grade 1 is worst, Grades 5 and 4 being commercially viable and Grade 3 or less, not meeting minimal requirements.

Based on comparison between Example 3 and Example 5, it is found that the air flow rate of 1 m/second tends to improve the uneven thickness more, compared to 2 m/second.

Furthermore, when as low viscosity solvent, methyl isobutyl ketone is compared to methyl ethyl ketone, methyl ethyl ketone having a lower boiling point is found to markedly improve the uneven thickness for time “t”.

Further, regarding coating compositions into which surface active agents are incorporated, the spot defects are more pronounced as observed in Comparative Example 3. However, shortening time “t” markedly overcomes these problems. Further, in a method in which the matting agent is incorporated into the coating composition, spot defects are more pronounced. However, the same effect as above is obtained by shortening Time t.

### Example 10 through 13

Similarly, with the use of the coating and drying apparatus in FIG. 1, coating and drying of Examples 10 through 13, and Comparative Examples 5 and 6 was carried out onto 300 mm wide and 100 μm thick surface-roughened aluminum support having a center line average height Ra of 0.3, while varying coating compositions and coating speed. The center line average height Ra of each of these coated surfaces was measured. Table 2 show the results.

TABLE 2

| | | | Viscosity | | | Ra after |
|---|---|---|---|---|---|---|
| | Solvent | Solvent | of Coating | U | t | Coating |
| | A | B | Composition | (cp) | (sec) | (μm) |
| Comparative | methyl | cyclo- | 3 | 20 | 6 | 0.07 |
| Example 5 | isobutyl | hexanone | | | | |
| | ketone | | | | | |
| Example 10 | methyl | cyclo- | 3 | 30 | 4 | 0.21 |
| | isobutyl | hexanone | | | | |
| | ketone | | | | | |
| Example 11 | methyl | cyclo- | 3 | 40 | 3 | 0.25 |
| | isobutyl | hexanone | | | | |
| | ketone | | | | | |
| Comparative | methyl | cyclo- | 2 | 20 | 6 | 0.12 |
| Example 6 | ethyl | hexanone | | | | |
| | ketone | | | | | |
| Comparative | methyl | cyclo- | 2 | 30 | 4 | 0.24 |
| Example 12 | ethyl | hexanone | | | | |
| | ketone | | | | | |
| Comparative | methyl | cyclo- | 2 | 40 | 3 | 0.27 |
| Example 13 | ethyl | hexanone | | | | |
| | ketone | | | | | |

As can be seen from Table 2, and as shown in FIG. 2(a), the nearer the surface roughness of a film coated onto a support approaches that of the coating surface of the support prior to coating, the more uniform the coated film thickness is found to be. On the contrary, as shown in FIG. 2(b), the less the surface roughness of a film coated on the support becomes compared to the coating surface roughness of the support before coating, the more non-uniform the coated film thickness itself is found to be. Accordingly, as is clearly seen from the results, the shorter the time before entry into the heating and drying zones, and further, the more the low boiling point solvent is incorporated, the more uniform the coated film thickness becomes.

According to the present invention, when a coating composition comprising an organic solvent is coated onto a continually moving support and subsequently dried, the unevenness and related problems on the coated film surface can be regulated, and at the same time, uniform film thickness can be obtained even though the coating surface of a support is rough.

1. A coating method comprises the following steps:
a step in which a coating composition comprising an organic solvent is coated onto a conveyed support, and a coating film is formed, and
a step in which the support coated with said coating composition is dried in a drying zone, wherein
the time prior to entry into said drying zone after said coating composition is coated onto said support is no more than 5 seconds.

2. The coating method of claim 1 wherein said support is heated and dried employing a heating means provided in said drying zone in said drying step.

3. The coating method of claim 1 wherein the air flow rate on said coated film prior to entry into said drying zone is preferably no more than 1 m/second after said coating composition is coated onto said support.

4. The coating method of claim 1 wherein the organic solvent contained in the coating composition preferably comprises an organic solvent component having a viscosity of no more than 1 cp, and a boiling point of no more than 100° C. at 20° C. and 1013.25 Pa.

5. The coating method of claim 1 wherein the coating composition comprises a surface active agent.

6. The coating method of claim 1 wherein the coating composition comprises a solvent and solid particles which are not soluble in the solvent.

7. The coating method of claim 1 wherein the center line average height of the coating surface of the above mentioned support is preferably at least 0.3 μm.

8. A coating method comprises the following steps:
a step in which a coating composition comprising an organic solvent is coated onto a conveyed support, and
a step in which the support coated with said coating composition is dried in a drying zone, wherein
an air flow rate on said coated film is no more than 1 m/second until entry into said drying zone after said coating composition is coated onto said support.

9. The coating method of claim 8 wherein the organic solvent contained in the coating composition preferably comprises an organic solvent component having a viscosity of no more than 1 cp, and a boiling point of no more than 100° C. at 20° C. and 1013.25 Pa.

10. The coating method of claim 8 wherein the coating composition comprises a surface active agent.

11. The coating method of claim 8 wherein the coating composition comprises a solvent and solid particles which are not soluble in the solvent.
